(19) United States
(12) Patent Application Publication
(10) Pub. No.: US 2022/0089265 A1
(43) Pub. Date: Mar. 24, 2022

(54) Cooled Outboard Engine Platform

(71) Applicant: Yanmar Marine International B.V., Almere (NL)

(72) Inventor: Claus Bruestle, Nordheim (DE)

(21) Appl. No.: 17/029,720

(22) Filed: Sep. 23, 2020

(51) Int. Cl. B63H 20/28; B63H 23/34; H02K 5/20; H02K 7/116; H02K 9/19; H02K 11/33

(52) U.S. Cl. CPC B63H 20/28; B63H 23/34; H02K 5/20; H02K 2213/12; H02K 9/19; H02K 11/33; H02K 7/116

(57) ABSTRACT

A cooled outboard engine platform including an electric motor having an output shaft for outboard propulsion, and an invertor for driving the electric motor. The platform further includes a cooling system having an open or closed cooling circuit for cooling the electric motor and/or the invertor with a cooling liquid.

### BACKGROUND

The invention relates to a cooled outboard engine platform.

Outboard engines are widely known for propulsion of boats in fresh or offshore waters. Typically, gasoline or diesel fueled internal combustion engines are used to power an outboard engine. More recently, electric motors have been used to power outboard engine arrangements, in response to the increasing performance of rechargeable batteries and other electric power generation means, for example fuel cells, as well as by environmental needs.

It is important to assure the safety and reliability of electric motors when used in an outboard engine, particularly where high power is required, for example higher than 100 kW. Sufficient cooling is important to assure the safety and reliability of an electric motor used in an outboard engine. In many embodiments, conventional air-cooling equipment does not provide the required cooling performance in all circumstances required to maintain the temperature of the motor and invertor in a normal operational temperature range. The cooling performance of conventional air-cooling equipment can be insufficient under any atmospheric conditions, but particularly when utilized during periods of hot atmospheric conditions.

Therefore, it is an aim of the present invention to minimize, solve or alleviate one or more of the above-mentioned disadvantages. In particular, the invention aims at providing a safe and reliable cooled outboard engine platform.

### BRIEF DESCRIPTION OF THE DRAWINGS

FIG. 1 shows a schematic side view of a cooled outboard engine platform according to the invention;

FIG. 2 shows a schematic bottom view of an adapter plate of the outboard engine platform shown in FIG. 1;

FIG. 3 shows a schematic cross-sectional side view of a cooling system of the cooled outboard engine platform shown in FIG. 1;

FIG. 4 shows a schematic cross-sectional top view of the cooling system shown in FIG. 3;

FIG. 5 shows a schematic system overview of the cooling system shown in FIG. 4, and

FIG. 6 shows a schematic side view of another cooled outboard engine platform according to the invention.

### DETAILED DESCRIPTION

According to an aspect of the invention, a cooled outboard engine platform is provided. The cooled outboard engine platform, also generally referred to as a cooled outboard engine, may comprise an electric motor having an output shaft for outboard propulsion, and an invertor for driving the electric motor, the platform further comprising a cooling system for cooling the electric motor and/or the invertor with a cooling liquid.

By providing a cooling liquid system, the electric motor and/or the invertor can be maintained within a pre-determined operational temperature range to realize a safer and more reliable cooled outboard engine platform.

In some embodiments, the cooled outboard engine platform includes a fluid tight enclosure enclosing a chamber that accommodates the electric motor and the invertor. The enclosure may house or be in communication with a cooling liquid interface for exchanging the cooling liquid in a fluid tight manner, thereby maintaining dry atmospheric conditions around the motor and invertor, as well as providing effective liquid cooling to the platform. The cooling liquid interface may include interconnection channels that are integrated in the enclosure, e.g. in an adapter plate supporting the electric motor and the invertor. In some embodiments, the interconnection channels run between interior chamber side connection openings and exterior side connection openings.

The cooling system may be of an open type, using seawater, lake water, river water or water from another environmentally available source as cooling liquid. An open cooling system configured to utilize seawater will typically include cooling channels in or on the electric motor and invertor that are corrosion resistant. In other embodiments, the cooling system may be of a closed type. A closed cooling system will typically include a heat exchanger in thermal communication with and exchanging thermal energy between each of a secondary cooling liquid in a closed secondary cooling circuit and a primary cooling liquid in a primary cooling circuit. The primary cooling circuit can be open and utilize environmentally available water as the primary cooling fluid. A closed cooling system with primary and secondary cooling circuits is advantageous in implementations where parts of the electric motor and/or invertor are not corrosion resistant.

In embodiments having a heat exchanger, the heat exchanger may have the same orientation as the electric motor output shaft, preferably extending along said output shaft, and more preferably having an arrangement that is mainly concentric to said shaft, thereby enabling a compact and efficient design. In addition, a driving shaft for propulsion may be sealed in a central channel of the heat exchanger that may having a mainly annular shaped structure surrounding the central channel for passage of the driving shaft.

In one embodiment, the heat exchanger has a standardized or modular design with standardized attachment mechanisms providing a heat exchanger that can be modified in dimensions with interchangeable parts providing the flexibility to match the heat exchanger to the power and thermal rating of a specific electric motor.

One embodiment of heat exchanger having modular construction may include stacked sections including pipe elements that are arranged in a concentric design around the output shaft of the electric motor, so as to facilitate easy assembly and de-assembly of the heat exchanger, and to enable flexible use of standardized components in different heat exchanger configurations.

In one specific embodiment, the heat exchanger includes a first series of cooling channels for downward flow of a closed circuit cooling liquid and a second series of cooling channels for upward flow of the closed circuit cooling liquid, and wherein the first and second series of cooling channels are arranged in respective mutually complementary annular sectors or adjacent semi-annular sectors, thereby providing an efficient concentric design.

Further in some embodiments, the cooling channels of the heat exchanger are connected to the exterior side connection openings of the cooling liquid interface via hose-less connections, e.g. using clamped pipe connections.

In embodiments having an adapter plate, a transmission unit can be interposed between the adapter plate and the heat exchanger, thereby maintaining an efficient and compact design.

The heat exchanger may comprise an output channel for flowing heated primary cooling liquid towards a gear casing of the outboard engine.

Further, the heat exchanger may be arranged for controlling a temperature of the closed-circuit cooling liquid below a selected temperature level, e.g. below about 45 degrees Celsius.

Thus are disclosed at least the following numbered embodiments:

1. A cooled outboard engine platform comprising, an electric motor having an output shaft for outboard propulsion, an invertor for driving the electric motor, and a cooling system for cooling the electric motor and/or the invertor with a cooling liquid.

2. A cooled outboard engine platform according to embodiment 1, further comprising, a fluid tight enclosure enclosing a chamber housing the electric motor and the invertor, and a cooling liquid interface associated with the fluid tight enclosure providing for the sealed exchange of the cooling liquid into and out of the enclosure.

3. A cooled outboard engine platform according to embodiment 2, wherein the cooling liquid interface comprises, one or more chamber side connection openings, one or more exterior side connection openings, and one or more interconnection channels between said chamber side and exterior side connection openings, wherein the interconnection channels are integrated in the enclosure.

4. A cooled outboard engine platform according to embodiment 3, wherein the fluid tight enclosure comprises an adapter plate supporting the electric motor and the inverter, and wherein the interconnection channels are integrated in the adapter plate.

5. A cooled outboard engine platform according to any of the preceding embodiments, wherein the cooling liquid is seawater.

6. A cooled outboard engine platform according to any of the preceding embodiments 1-4, wherein the cooling system includes a heat exchanger preferably having the same orientation as the electric motor output shaft and/or preferably extending along the electric motor output shaft and/or preferably having a mainly annular shaped structure surrounding a central channel for passage of a driving shaft.

7. A cooled outboard engine platform according to any of the preceding embodiments 6, wherein the heat exchanger comprises an array of internal tubes, preferably positioned concentric to the electric motor output shaft.

8. A cooled outboard engine platform according to any of the preceding embodiments 6-7, wherein the heat exchanger comprises two or more modular components, and wherein the adapter plate includes a standardized footprint sized to accept a selected modular component of the heat exchanger.

9. A cooled outboard engine platform according to any of the preceding embodiments 6-8, wherein the modular components of the heat exchanger comprise a plurality of stacked sections including pipe elements arranged concentrically around the output shaft of the electric motor.

10. A cooled outboard engine platform according to any of the preceding embodiments 6-9, wherein the heat exchanger comprises, a first series of cooling channels for downward flow of a closed circuit cooling liquid, a second series of cooling channels for upward flow of the closed circuit cooling liquid, and wherein the first and second series of cooling channels are arranged in mutually complementary annular sectors, respectively.

11. A cooled outboard engine platform according to any of the preceding embodiments 6-10, wherein at least one of the exterior side connection openings of the cooling liquid interface is engaged through a hoseless connection with a corresponding cooling channel of the heat exchanger.

12. A cooled outboard engine platform according to any of the preceding embodiments 6-11, wherein at least one of the exterior side connection openings of the cooling liquid interface is connected to a corresponding cooling channel of the heat exchanger through a clamped pipe connection.

13. A cooled outboard engine platform according to any of the preceding embodiments 6-12, further comprising a transmission unit interposed between the adapter plate and the heat exchanger.

14. A cooled outboard engine platform according to any of the preceding embodiments 6-13, wherein the heat exchanger comprises an output channel for flowing heated primary cooling liquid towards a gear casing of the outboard engine.

15. A cooled outboard engine platform according to any of the preceding embodiments 6-14, wherein the heat exchanger is arranged for controlling a temperature of the closed circuit cooling liquid below about 45 degrees Celsius.

Further advantageous embodiments according to the invention are described in the following claims.

It should be noted that the technical features described above or below may each on its own be embodied in an outboard engine arrangement, i.e. isolated from the context in which it is described, separate from other features, or in combination with only a number of the other features described in the context in which it is disclosed. Each of these features may further be combined with any other feature disclosed, in any combination.

The invention will be further elucidated on the basis of exemplary embodiments which are represented in the drawings. The exemplary embodiments are given by way of non-limiting illustration of the invention. In the figures identical or corresponding parts are represented with the same reference numerals. The drawings are only schematic representations of embodiments of the invention, which are given by manner of non-limited examples.

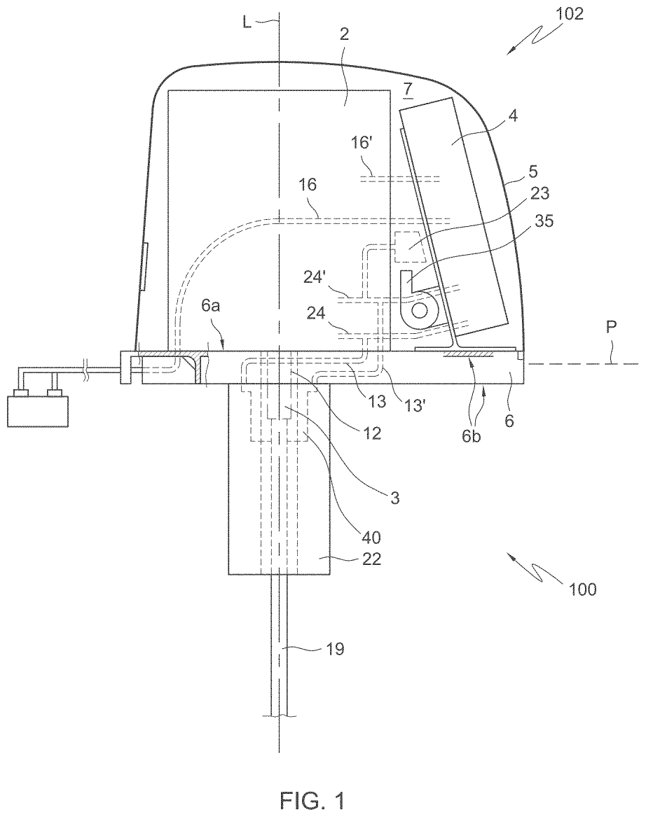

FIG. 1 shows a schematic side view of a cooled outboard engine platform 100 or cooled outboard engine according to the invention. The platform 100 comprises an electric motor 2 having an output shaft 3 for outboard propulsion, and an invertor 4 for driving the electric motor 2. The electric motor 2 may for example be an AC motor, such as a permanent-magnet synchronous motor, PMSM. However, other electric motor types including AC motors, such as an asynchronous or induction motor, may also be used. The platform is provided with electric power lines 16, 16′ extending from input power lines 9 and 9′ through cable box 18 to deliver power to the invertor 4 and/or electric motor 2 from DC power source 11.

The platform 100 also includes an adapter plate 6 that supports the electric motor 2 as well as the invertor 4. The adapter plate 6 may be formed from a metal or metals, e.g. using a sandcasting process, another casting process, or an alternative technique. Generally, the adapter plate 6 has a predominantly flat structure having a top side or a top surface 6a and a bottom side or a bottom surface 6b opposite to the top surface 6a. In the illustrated embodiment, the electric motor 2 is mounted on the top surface 6a of the adapter plate 6 such that the output shaft 3 is oriented substantially transverse to the generally planar orientation of the adapter plate 6. In other words, a longitudinal axis L of the output shaft 3 is oriented mainly transverse to a plane P defined by a surface of the adapter plate 6 or wherein the adapter plate 6 extends. The platform 100 further includes a coupler 40 providing a sealed coupling of the output shaft 3 of the electric motor 2 to a driving shaft 19.

The platform 100 further includes a cowling 5 forming a top cover of a chamber 7 wherein the electric motor 2 and the invertor 4 are enclosed. The cowling 5 may, for example, be dome shaped as shown in FIG. 1 or may have another shape, such as a box or cylinder. The cowling 5 can be made from various materials including metal(s) and/or synthetic materials such as plastic(s) and/or composites, etc. The cowling 5 can be fabricated by any suitable process, including but not limited to an injection molding process, such as a high-pressure permanent molding technology, or a blow molding or thermoforming process. Optionally, the cowling 5 may be integrally formed, for example as a one-piece shell. In other embodiments, the cowling may be composed from multiple modules that are coupled to each other.

Preferably, the cowling 5 is mounted in sealed engagement with the adapter plate 6, creating a fluid tight and/or gastight sealed enclosure 102 enclosing the chamber 7 that accommodates the electric motor 2 and the invertor 4.

The platform 100 further comprises a cooling system 22 for cooling the electric motor 2 and/or the invertor 4 and/or, optionally, electric power lines 16, 16′ with a cooling liquid.

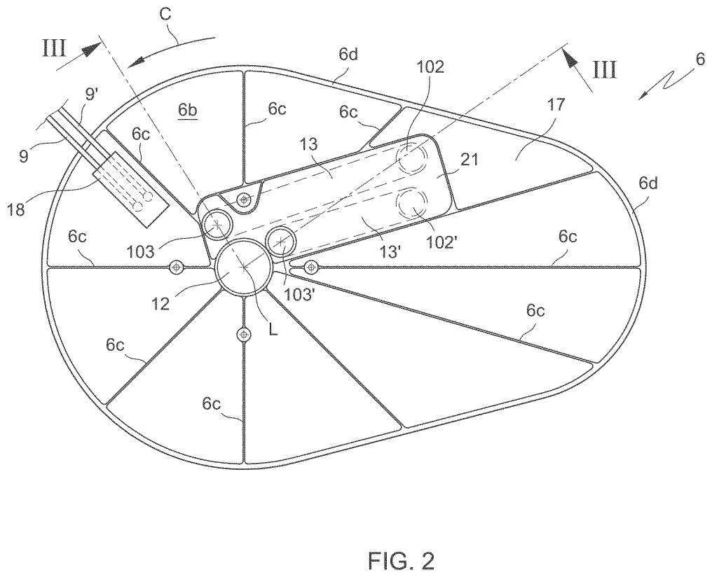

The adapter plate 6 may be provided with a cooling liquid interface, as described below, to facilitate the sealed exchange of cooling liquid between the chamber 7 and the cooling system 22. A representative cooling liquid interface is described in more detail referring to FIG. 2. In the illustrated embodiment an ingoing cooling liquid channel 13 and an outgoing cooling liquid channel 13′, also referred to as interconnection channels 13, 13′, are integrated in the adapter plate 6. At the exterior side, the interconnection channels 13, 13′ end in exterior side connection openings. At the chamber side, the ingoing and outgoing channels 13, 13′ are connected, via chamber side connection openings, to liquid cooling lines 24, 24′ to cool the invertor 4, the electric motor 2 and/or, optionally, electric power lines 16, 16′. The platform 100 may include a pump unit 35 arranged in the chamber 7 to pump the cooling liquid towards and from the chamber 7. Alternatively, the pump unit 35 may be located outside the chamber 7.

It is further noted that the cooling liquid channels 13, 13′ may be part of an open or closed liquid cooling system. In the former case, the cooling liquid may be sea, lake or river water; in the latter case, the cooling liquid may a selected heat transfer fluid, for example, a glycol water mixture or another cooling liquid that may be indirectly cooled by environmental water.

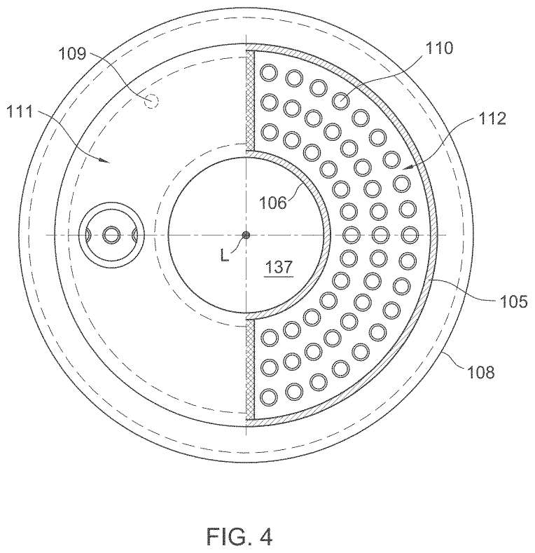

FIG. 2 shows a bottom view of the adapter plate 6 of the outboard engine platform 100 illustrated in FIG. 1. The adapter plate 6 has an opening 12 for receiving the output shaft 3 of the electric motor 2, the opening thus serving as an output port for fluid tight passage of said output shaft 3 from the chamber 7, as described in more detail referring to the coupler 40 shown in FIG. 4. The adapter plate 6 shown in FIG. 2 is an exemplary implementation of the supporting structure for an outboard engine mentioned above. The adapter plate 6 shown in FIG. 2 includes a generally planar deck 17 having ribs 6c extending from the bottom side 6b of the plate downwardly, transverse to the plane P defined by the adapter plate 6, and generally parallel to the longitudinal axis L of the output shaft 3. Further, the adapter plate 6 includes an exterior rib or rim 6d defining a contour of the plate in a circumferential direction C around the longitudinal axis L. In the illustrated embodiment, the contour has a mainly oval shape. However, generally, the contour may have other shapes such as an ellipse, a circle, another curved contour or a polygon. The exterior rim 6d extends downwardly from the bottom surface 6b, mainly parallel to the other ribs 6c.

The deck 17 generally extends from the opening 12 to the exterior rim 6d, forming the mainly flat bottom side 6b of the plate 6, with discrete segments being defined by the ribs 6c. In some embodiments, plate 6 is integrally formed. One specific portion of the deck 17, defines an interface 21, typically located adjacent the opening 12. The interface 21 defines a region where a cooling liquid may be exchanged into and out of the chamber 7 in a sealed manner. The interface 21 integrated in the adapter plate 6 includes the ingoing cooling liquid channel 13 and the outgoing cooling liquid channel 13′ mentioned above with reference to FIG. 1.

Typically, the interface 21 includes an interior inlet opening 102 and an interior outlet opening 102′, both opening into the chamber 7. Typically, the interface 21 also includes an exterior inlet opening 103 and an exterior outlet opening 103′ both opening away from the chamber 7. The ingoing cooling liquid channel 13 runs from the exterior inlet opening 103 to the interior inlet opening 102, and the outgoing cooling liquid channel 13′ runs from the exterior outlet opening 103′ to the interior outlet opening 102′. In the illustrated embodiment, the exterior inlet opening 103 and the exterior outlet opening 103′ are located near the opening 12 so as to connect to a heat exchanger located below the adapter plate 6 concentric to the longitudinal axis L of the output shaft 3 or to another device providing input/output cooling liquid such as direct cooling using fresh water or seawater. The illustrated interface 21 has a mainly rectangular shape, but in other embodiments, the interface 21 may have another shape, e.g. a triangular shape or another polygon shape. The deck 17 including the interface 21 forms a pattern of regions adjoining each other forming the bottom side 6b of the generally flat plate 6.

It is noted that the adapter plate 6 can be implemented without a deck 17 and rib 6c/rim 6d configuration. For example, the adapter plate 6 could be implemented with a solid, honeycomb, hollow, or other structure for supporting electric motors of various sizes and weights. In any embodiment, the ingoing and outgoing cooling liquid channels 13, 13′ may optionally be integrated in the adapter plate 6.

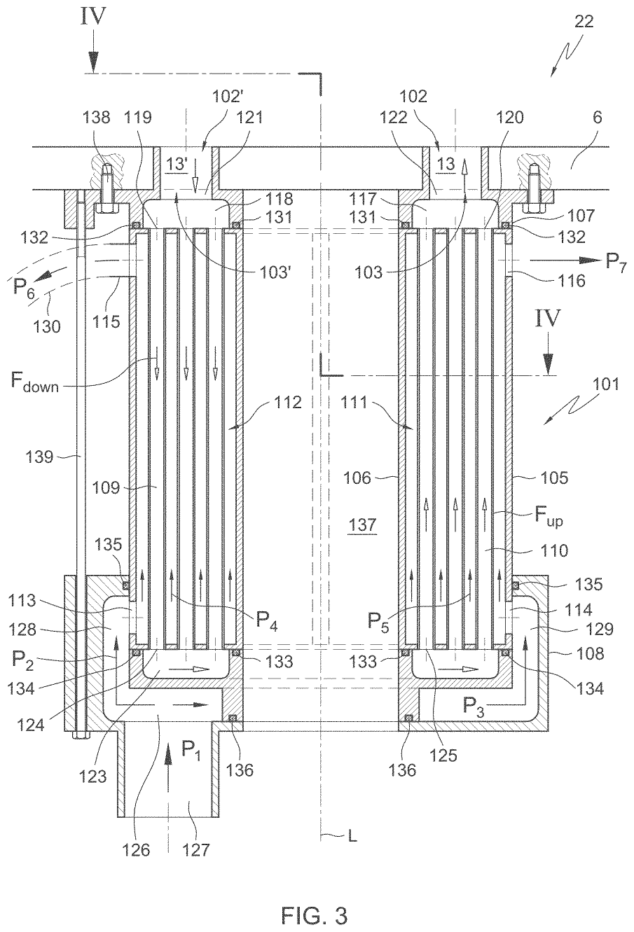

In the embodiment illustrated with reference to FIG. 3, the cooling system includes a heat exchanger 22 forming part of a closed liquid cooling system. The cooling liquid flowing within the closed liquid cooling system is referred to herein as a secondary cooling liquid and may be a glycol water mixture or another cooling liquid that may be indirectly cooled by environmental water referred to herein as a primary cooling liquid.

FIG. 3 shows a schematic cross-sectional side view of the cooling system 22 of the cooled outboard engine platform 100 shown in FIG. 1, along cross section III. The heat exchanger 22 is mounted or positioned below the adapter plate 6 and extends along and mainly concentric to the output shaft 3 of the electric motor 2, the heat exchanger 22 and the electric motor output shaft 3 having predominantly the same orientation, along the longitudinal axis L of the output shaft 3 electric motor 2. The heat exchanger 22 further has a mainly annular shaped structure surrounding a central channel 137 aligned with the longitudinal axis L of the electric motor output shaft 3, for passage of the driving shaft 19.

As shown in FIG. 3, the heat exchanger 2 includes an array of heat exchanger tubes or internal tubes predominantly aligned with the longitudinal axis L of the electric motor output shaft 3. As illustrated elsewhere, the driving shaft 19 may pass through the central channel 137 of the heat exchanger 22.

As noted above, in certain embodiments, the heat exchanger 22 is provided with a modular design or construction, including stacked sections that may be interchanged to provide a selected thermal capacity. A modular heat exchanger 22 may include, but is not limited to a chamber section 101, a top cover section 107 on top of the chamber section 101, and a bottom cover section 108 at the bottom of the chamber section 101. The respective stacked sections 101, 107, 108 are mounted in sealed engagement with each other, preferably using a bolted connection and O-rings, gaskets, pressure fittings, or another method of providing a seal between each section.

The chamber section 101 includes pipe elements 109, 110, also referred to as internal tubes, pipes or channels, that may be arranged in a concentric design around the longitudinal axis L of the output shaft 3 of the electric motor 2. The height of the chamber section 101, i.e. the dimension of the chamber section 101 along the longitudinal axis L of the electric motor output shaft 3 may be selected to provide sufficient cooling for the electric power output and thermal requirements of the electric motor 2, inverter 4, and associated elements. Generally, when the power of the electric motor increases, the height of the chamber 101 selected to cool that electric motor may be increased.

FIG. 4 shows a schematic cross-sectional top view of the cooling system 22 shown in FIG. 3, along cross section IV. The chamber section 101 includes a first and a second semi-annular chamber 111, 112 of similar shape, together forming a mainly closed annular chamber section 101 concentric to the longitudinal axis L. Preferably, the first and second chamber 111, 112 are arranged as mutually complementary annular sectors, respectively. The first and second chamber 111, 112 each have a radial exterior wall 105 and a radial interior wall 106, both radial exterior walls 105 together forming a mainly closed exterior wall symmetrically positioned around the longitudinal axis L, and both radial interior walls 106 together forming a mainly closed interior wall also symmetrically positioned around the longitudinal axis L and radially bounding the central channel 137.

The first chamber 111 includes a first series of cooling channels 109 for downward flow F_{down} of the closed circuit, secondary cooling liquid. Similarly, the second chamber 112 includes a second series of cooling channels 110 for upward flow Fᵤₚ of the closed circuit, secondary cooling liquid. Further, the first and second chamber 111, 112 each include inflow openings 113, 114, near a bottom portion of the chamber section 101, for flowing a primary cooling liquid into the respective chamber 111, 112. Similarly, the first and second chamber 111, 112 each include outflow openings 115, 116, near a top portion of the chamber section 101, for flowing the primary cooling liquid from the respective chamber 111, 112 outwardly. The inflow openings 113, 114 can be implemented as multiple openings preferably distributed evenly in the circumferential direction C. Similarly, embodiments having multiple outflow openings 115, 116 preferably have the outflow openings 115, 116 distributed evenly in the circumferential direction C. Alternatively, a single inflow opening and/or a single outflow opening can be placed into fluid communication with the first and/or second chamber 111, 112, respectively.

The pipe elements or channels 109, 110, the radial exterior wall 105 and the radial interior wall 106 are preferably made from stainless steel or another non-corrosive material. Preferably, the pipe elements 109, 110 are made from austenitic steel. In total, tens or hundreds of pipe elements 109, 110 can be used, e.g. 100, 150 or 200 pipe elements. As one non-limiting example, the pipe elements may have an outer diameter ranging between about 5 mm and about 15 mm, e.g. about 9 mm, and may have an inner diameter also ranging between about 5 mm and about 15 mm, e.g. about 8.7 mm. However, pipe elements having other dimensions can be utilized as well, including but not limited to pipe elements 109, 110 having larger or smaller inner and/or outer diameters and selected wall thicknesses.

Referring again to FIG. 3, the top cover section 107 mounted in sealed engagement with the chamber section 101 includes or defines a first and a second channel section 117, 118. In the illustrated embodiment, the first and second channel section are separate from each other, and provided, at their lower side, with respective openings 119, 120. The openings 119, 120 are mated in sealed engagement with the upper portions of the first and second series of cooling channels or tubes 109, 110. The first and second channel section 117, 118 are further provided, at a top side, with openings 121, 122 located to be aligned with corresponding exterior side connection openings 103, 103′ of the cooling liquid interface 21 of the adapter plate 6. Thus, when the heat exchanger 22 is mounted to an adapter plate 6, the exterior side connection openings 103, 103′ of the cooling liquid interface 21 form direct hose-less connections with the corresponding first and second channel section 117, 118 and the corresponding cooling channels 109, 110 of the heat exchanger 22. Said hose-less connections between the openings 119, 121 and the exterior side connection openings 103, 103′ are clamped into tight and sealed engagement, for example by bolts used to attach the heat exchanger 22 to the adapter plate 6. A fluid-tight seal at the hose-less connection may be enhanced by providing suitable O rings, gaskets or other sealing structures at the connection.

Similarly, the bottom cover section 108 includes a common channel section 123 that is provided, at its top side, with respective openings 124, 125 receiving corresponding lower portions of the first and second series of cooling channels or tubes 109, 110 in a sealed engagement. Thus, the bottom parts of the first and second series of cooling channels or tubes 109, 110 are in fluid communication with the common channel section 123 via hose-less connections. Said hose-less connections can be clamped into sealed engagement, preferably using bolts or a similar attachment method. Alternatively, the pipe elements 109, 110 can be permanently bonded into sealed engagement with one or both of the top cover section 107 and the bottom cover section 108 using a brazing/welding process, adhesives, or another suitable attachment method.

Further, the bottom cover section 108 includes a primary circuit channel section 126 positioned around a lower portion of the chamber section 101 and having an inlet 127 for the inflow of the primary cooling liquid, e.g. seawater, and a first and a second outflow openings 128, 129 aligned with the respective inflow openings 113, 114 of the respective chambers 111, 112. The selected length of the inflow section 127 may vary, depending for example on the shaft length and/or a position of a gear casing.

In certain embodiments, the top cover section 107 and/or the bottom cover section 108 may have a modular design itself, for example, the top cover section 107 and the bottom cover section 108 may include stacked sub modules. Preferably, the top cover section 107 and the bottom cover section 108 are made from aluminum.

The respective stacked sections 101, 107, 108 are mounted to each other and to the adapter plate 6, preferably using a bolt construction and O-rings 131, 132, 133, 134, 135, 136, as shown in FIG. 3 using first bolts 138 mounting the top cover section 107 to the adapter plate 6, and second bolts 139, the second bolts 139 being longer than the first bolts 138 and extending from the bottom cover section 108 into corresponding threaded holes in the top cover section 107, thereby sandwiching the chamber section 101 between the top cover section 107 and the bottom cover section 108. Alternatively, the stacked sections 101, 107, 108 in the adapter plate 6 may be mounted to each other using another suitable construction method and other suitable sealing methods, including but not limited to gaskets, welded joints, pressure fittings and the like. Advantageously, the bottom cover section 108, and, subsequently, the chamber section 101 can be removed from the top cover section 107 without removing the top cover section 107 that is attached to the adapter plate 6, thereby providing ready access to the interior of the heat exchanger 22 for service by qualified personnel.

As best shown in FIG. 3, during operation of the heat exchanger 22 the primary cooling liquid flows via a first flow path P₁ from the inflow section 127 of the bottom cover section 108 into the channel section 126. Then, the flow is divided into two sub flows flowing to the first and second chambers 111, 112, respectively, via a second path P₂ in the first outflow section 128 and the first inflow opening 113, and via a third path P₃ in the second outflow section 129 and the second inflow opening 114, respectively. Then, the primary cooling liquid flows upwardly via the fourth path P₄ and the fifth path P₅, in the first and second chambers 111, 112, respectively. In the first and second chambers 111, 112 the primary cooling liquid exchanges heat with and cools the secondary liquid in the first and second series of cooling channels 109, 110. Subsequently, the primary cooling liquid flows from the first and second chamber 111, 112 outwardly, via a sixth path P₆ and a seventh path P₇, respectively, through the respective outflow openings 115, 116, and into an output channel 130 that may be formed as a hose, tube, pipe, or other conduit that may optionally be provided for flowing the heated primary cooling liquid towards anyone of specific inflow opening in the drive shaft housing, a gear casing of the outboard engine, towards another module, or directly back into the surrounding water. In the illustrated embodiment, the primary cooling liquid flows via the outflow openings 115, 116 directly into a drive shaft housing from where it flows outwardly through the gear casing into the surrounding environmental water.

The primary cooling liquid may be circulated by an optional pump unit and/or by directing a first cooling liquid inflow opening towards a propulsion direction of the boat.

During operation, the secondary cooling liquid flows in downward flow F_{down} in the second series of cooling channels 110 arranged in the second chamber 112. As the secondary cooling liquid flows through the second chamber 112 it exchanges heat with and is cooled by the surrounding upwardly flowing primary cooling liquid, using the heat exchanger principle of co-flow and counter flow on the hot side. Subsequently, the secondary cooling liquid flows via the common channel section 123 towards the first chamber 111, and via the first series of cooling channels 109 in an upward flow Fᵤₚ towards the first channel section 117 of the top cover section 107. The secondary cooling liquid then flows via the exterior inlet opening 103 into the ingoing channel 13 of the cooling liquid interface 21. Then, the secondary cooling liquid flows, via the interior inlet opening 102, into a first secondary liquid cooling line 24 to cool the invertor 4, the electric motor 2 and/or, optionally, electric power lines 16, 16′. Subsequently, the heated secondary liquid cooling liquid flows via a second secondary liquid cooling line 24′ back, via the interior outlet opening 102′ into the outgoing liquid channel 13′, and then, via the exterior outlet opening 103′ into the second channel section 118 of the top cover section 107, and back into the second series of cooling channels 110 in the second chamber 112, thus forming a closed circuit for the secondary cooling liquid.

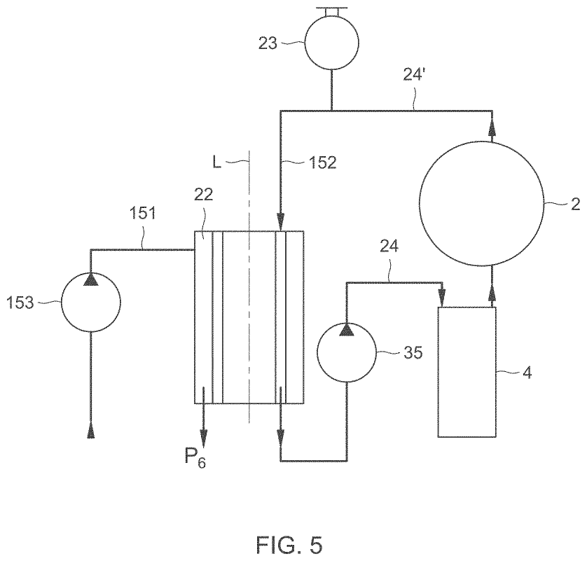

The secondary cooling liquid flow is circulated by the pump unit 35. Optionally, an expansion reservoir 23 may be provided connected to the closed secondary cooling liquid circuit, as described referring to FIG. 5, to accommodate and limit any temperature induced pressure increase in said circuit. Preferably, the expansion reservoir 23 is installed above the cooling liquid entrance of the motor 2 and the invertor 4, respectively.

The first and second secondary liquid cooling lines 24, 24′ may include hoses, located in the chamber 7 where the electric motor 2 and the invertor 4 are located. In a specific embodiment, the cooling lines may include a first hose running between the interior inlet opening 102 and an invertor inlet, a second hose running between an invertor outlet and an electric motor inlet, a third hose running between an electric motor outlet and the interior outlet opening 103, and a fourth hose running from the first hose and the expansion reservoir 23.

FIG. 5 is a schematic system overview of the cooling system 22 shown in FIGS. 3 and 4. Here, an open primary cooling liquid circuit 151 and a closed secondary cooling liquid circuit 152 are shown, exchanging heat from the secondary cooling liquid circuit 152 to the primary cooling liquid circuit 151 within the heat exchanger 22. The open primary cooling liquid circuit 151, may be supplied by environmental water received through an opening below the waterline, for example through an opening in a gear case of the platform. The circulation of the primary cooling liquid may be caused by a water pump 153 that is preferably arranged in or near the gear case, upstream of the heat exchanger 22. The water pump 153 may have a capacity of about 10 liters per minute to about 100 liters per minute, for example about 60 liter per minute. The water pump flow rate may be selected depending on the electric power output and cooling requirements of the electric motor. Downstream from the heat exchanger, the primary cooling liquid may flow back to the water pump, via the sixth flow path P₆.

Circulation of the secondary cooling liquid may be caused by the pump unit 35 positioned in or near the chamber 7. The pump unit 35 may have a capacity of about 5 liters per minute to about 60 liters per minute, for example about 20 liters per minute at a specific system back pressure, for example 1 bar. The secondary cooling liquid flow rate, and pump unit 35 size may be selected depending on the electric power and associated cooling requirements of the electric motor and inverter. The secondary cooling liquid circuit 152 includes an expansion reservoir 23 as described above. Said secondary cooling liquid circuit 152 can be filled, refilled, topped off or otherwise accessed via the expansion reservoir 23. In the illustrated embodiment, the invertor 4 and the electric motor 2 are cooled by the secondary cooling liquid in series, with the invertor 4 being cooled prior to the electric motor 2. However, the order may be reversed such that the invertor 4 is cooled with cooling liquid having previously cooled the electric motor 2. Alternatively, the secondary cooling liquid circuit 152 may be split for cooing the electric motor 2 and the invertor 2 in a parallel manner. Also, the electric power lines may be cooled by the secondary cooling liquid circuitry 152, if required.

The heat exchanger 22 may be sized and configured for maintaining a temperature of the secondary cooling liquid below a predefined temperature level, e.g. about 45 degrees Celsius, during normal operational conditions of the engine platform 100. Optionally, a control module may be provided for controlling operation of at least one pump unit 35 and/or 153 to control a liquid flow rate of the primary and/or secondary cooling liquid, depending on temperature data sensed by a cooling liquid temperature sensor.

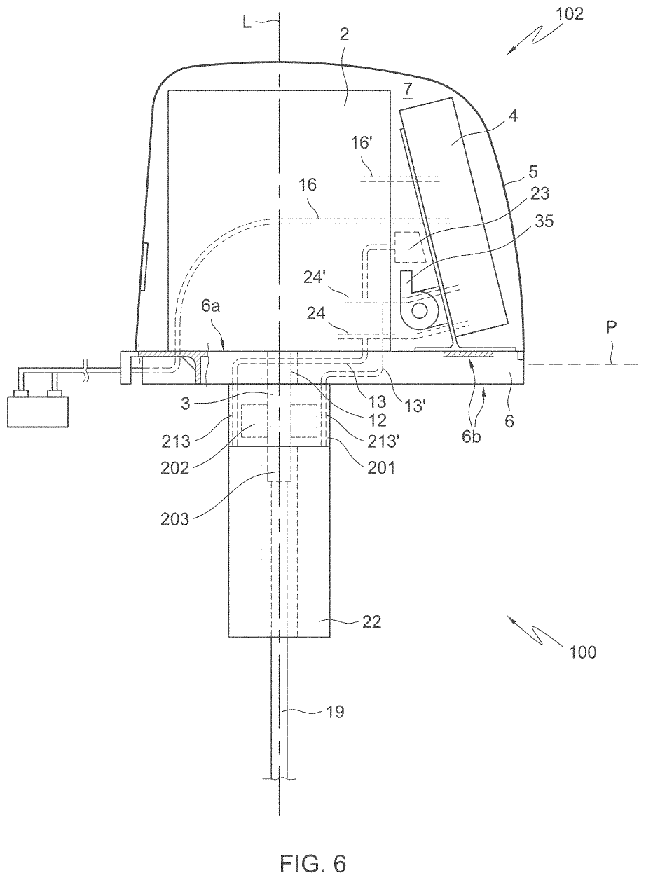

FIG. 6 is a schematic side view of an alternative cooled outboard engine platform 100 according to the invention. In the illustrated embodiment, a transmission unit 201 is interposed between the adapter plate 6 and the heat exchanger 22, thereby maintaining an efficient and compact design. The transmission unit 201 is positioned concentrically relative to the longitudinal axis L of the output shaft 3 and includes an input side connected to the output shaft 3 of the electric motor 2, a transmission mechanism 202, e.g. a planetary type transmission mechanism, and a transmission output shaft 203 connected to the driving shaft 19. In one embodiment, transmission output shaft 203 carries an internal spline and is made from corrosion resistant material. An upper end of the driving shaft 19 is received in and engaged with the internal spline of the transmission output shaft 203 such that the transmission output shaft 203 rotationally engages said driving shaft 19. The transmission mechanism 202 is configured to provide a transmission ratio between the output shaft 3 of the electric motor 2, as input shaft of the mechanism 202, and the transmission output shaft 203, as output shaft of the mechanism 202 or driving shaft 19. The transmission ratio may be selected to be larger then unity, e.g. about 1.25 to match an optimal operational rotational speed of the electric motor and to provide an optimal operational rotational speed of the driving shaft 19 and a propeller driven by the driving shaft 19. Alternatively, the transmission ratio may have any other suitable value, e.g. greater than about 1.25 or smaller than about 1.25, e.g. 1 or smaller than 1, e.g. about 0.75. Alternatively, the transmission unit 201 may provide a variable transmission ratio between the output shaft 3 and driving shaft 19.

In the illustrated embodiment, the transmission unit 201 further includes passages 213, 213′ interconnecting the exterior inlet opening 103 and the exterior outlet opening 103′ of the interface 21 to the respective openings 121, 122 of the first and second channel section 117, 118 of the top cover section 107 of the heat exchanger 22.

It is noted that in the shown embodiment, a radial dimension of the transmission unit 201, i.e. a dimension mainly transverse to the longitudinal axis L, is substantially the same as a radial dimension of the heat exchanger 22. By designing the transmission unit 201 and the heat exchanger such that they have approximately the same diameter, a layout having optimal space usage within the platform 100 may be realized. Alternatively, the diameter of the transmission unit 201 may be smaller or larger than the diameter of the heat exchanger 22. Alternatively, in principle, the transmission unit 201 may have a larger diameter than the heat exchanger 22.

Optionally, the cooled outboard engine platform 100 shown in FIG. 6 can be implemented with a coupler 40 as described above, especially if the transmission mechanism includes corrodible elements, including but not limited to elements of the transmission mechanism at the driving shaft side. In embodiments having a coupler 40, the transmission output shaft 203 can be connected at the input side of the coupler and the driving shaft 19 can be connected at the output side of the coupler 40.

The invention is not restricted to the embodiments described above. It will be understood that many variants are possible.

It is noted that, as an alternative implementation to the above described closed liquid cooling system, the cooling system can be implemented as a so-called open liquid cooling system, the cooling liquid being sea water, lake water or another environmental water source.

It is also noted that the cooling system including a heat exchanger as described above is not limited to application with a cooled outboard engine platform as described herein, specifically a platform having an electric motor having an output shaft for outboard propulsion, and an invertor for driving the electric motor. The cooling system can also be applied more generally with any engine or power source as a cooling system having a tubular arrangement that is mainly concentric around the drive shaft, preferably having a modular construction including stacked sections.

It is noted that, alternatively, the cooling system may have no heat exchanger. Then, the cooling system may e.g. be constructed as an open cooling liquid circuitry, e.g. for cooling the motor, the invertor and/or the power lines directly with seawater.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

What is claimed is:

1. A cooled outboard engine platform comprising:
an electric motor having an output shaft for outboard propulsion;
an invertor for driving the electric motor; and
a cooling system for cooling the electric motor and/or the invertor with a cooling liquid.

2. A cooled outboard engine platform according to claim 1, further comprising:
a fluid tight enclosure enclosing a chamber housing the electric motor and the invertor; and
a cooling liquid interface associated with the fluid tight enclosure providing for a sealed exchange of the cooling liquid into and out of the enclosure.

3. A cooled outboard engine platform according to claim 2, wherein the cooling liquid interface comprises:
one or more chamber side connection openings;
one or more exterior side connection openings; and
one or more interconnection channels between said chamber side and exterior side connection openings, wherein the interconnection channels are integrated in the enclosure.

4. A cooled outboard engine platform according to claim 3, wherein the fluid tight enclosure comprises an adapter plate supporting the electric motor and the inverter, and wherein the interconnection channels are integrated in the adapter plate.

5. A cooled outboard engine platform according to claim 1, wherein the cooling liquid is seawater.

6. A cooled outboard engine platform according to claim 1, wherein the cooling system includes a heat exchanger preferably having the same orientation as the electric motor output shaft and/or preferably extending along the electric motor output shaft and/or preferably having a mainly annular shaped structure surrounding a central channel for passage of a driving shaft.

7. A cooled outboard engine platform according to claim 6, wherein the heat exchanger comprises an array of internal tubes, positioned concentric to the electric motor output shaft.

8. A cooled outboard engine platform according to claim 6, wherein the heat exchanger comprises two or more modular components, and wherein the adapter plate includes a standardized footprint sized to accept a selected modular component of the heat exchanger.

9. A cooled outboard engine platform according to claim 6, wherein the modular components of the heat exchanger comprise a plurality of stacked sections including pipe elements arranged concentrically around the output shaft of the electric motor.

10. A cooled outboard engine platform according to claim 6, wherein the heat exchanger comprises:
a first series of cooling channels for downward flow of a closed circuit cooling liquid; and
a second series of cooling channels for upward flow of the closed circuit cooling liquid, and wherein the first and second series of cooling channels are arranged in mutually complementary annular sectors, respectively.

11. A cooled outboard engine platform according to claim 6, wherein at least one of the exterior side connection openings of the cooling liquid interface is engaged through a hoseless connection with a corresponding cooling channel of the heat exchanger.

12. A cooled outboard engine platform according to claim 6, wherein at least one of the exterior side connection openings of the cooling liquid interface is connected to a corresponding cooling channel of the heat exchanger through a clamped pipe connection.

13. A cooled outboard engine platform according to claim 6, further comprising a transmission unit interposed between the adapter plate and the heat exchanger.

14. A cooled outboard engine platform according to claim 6, wherein the heat exchanger comprises an output channel for flowing heated primary cooling liquid towards a gear casing of the outboard engine.

15. A cooled outboard engine platform according to claim 6, wherein the heat exchanger is arranged for controlling a temperature of the closed circuit cooling liquid below about 45 degrees Celsius.
